(19) United States
(12) Patent Application Publication
(10) Pub. No.: US 2009/0186258 A1
(43) Pub. Date: Jul. 23, 2009

(54) ION CONDUCTOR AND FUEL CELL

(75) Inventors: Kengo Makita, Kanagawa (JP); Shinichi Uesaka, Kanagawa (JP); Hiroyuki Morioka, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/093,935

(22) PCT Filed: Sep. 18, 2007
(86) PCT No.: PCT/JP2007/068076

§ 371 Date: Jun. 3, 2008

(30) Foreign Application Priority Data
Sep. 26, 2006 (JP) 2006-260791

(51) Int. Cl. H01M 8/08; H01M 8/00

(52) U.S. Cl. 429/46; 429/12

(57) ABSTRACT

An ion conductor that has high ion conductivity, is hardly affected by environmental change, and thus can improve the safety is provided. As a first fluid F1 containing an electrolyte, the ion conductor containing an ionic solid having ion conductivity and a dispersion medium for dispersing the ionic solid is flown through an electrolyte flow path between a fuel electrode and an oxygen electrode. Despite the solid dispersion solution, the ion conductivity is high. In addition, in the case where the dispersion medium is evaporated according to the environmental change, only the ionic solid remains. Accordingly, there is no possibility to corrode surrounding members and thus the safety is high. As the ionic solid, an ion-exchange resin such as a styrene-based cation-exchange resin and a polyperfluoroalkyl sulfonic acid-based resin is preferable. The ion conductor is prepared by mixing 15 wt % of the ion-exchange resin with water as the dispersion medium, and pulverizing the mixture by a ball mill.

### CROSS REFERENCE TO RELATED APPLICATIONS

The present application claims priority to Japanese Patent Application No. 2006-260791 filed on Sep. 18, 2007, the entire contents of which is being incorporated herein by reference.

### BACKGROUND

The present disclosure relates to an ion conductor suitable for an electrochemical device such as a Direct Methanol Fuel Cell (DMFC) in which methanol is directly supplied to a fuel electrode to initiate a reaction, and a fuel cell.

Indicators exhibiting characteristics of a battery include an energy density and an output density. The energy density is an energy cumulative amount per unit mass of the battery. The output density is an output amount per unit mass of the battery. A lithium ion secondary has two characteristics of the relatively high energy density and the significantly high output density, and is highly-quality finished. Thus, the lithium ion secondary battery is widely used as a power source for mobile devices. However, in recent years, there is a tendency that the power consumption of the mobile devices is increased as the mobile devices become sophisticated. Accordingly, it is demanded that the energy density and the output density of the lithium ion secondary battery are further improved.

Solutions thereof include changing the electrode material composing the cathode and the anode, improving the coating method of the electrode material, improving the method of enclosing the electrode material and the like. Researches on improving the energy density of the lithium ion secondary battery have been made, but it is still a far-out technology to achieve the practical use. In addition, unless the component material used for the current lithium ion secondary battery is changed, it is hard to expect substantial improvement of the energy density.

Therefore, it is an urgent necessity to develop a battery having a higher energy density instead of the lithium ion secondary battery. A fuel cell is one of the strong candidates.

The fuel cell has a structure in which an electrolyte is arranged between an anode (fuel electrode) and a cathode (oxygen electrode). A fuel is supplied to the fuel electrode, and air or oxygen is supplied to the oxygen electrode. In the result, redox reaction in which the fuel is oxidized by oxygen in the fuel electrode and the oxygen electrode is initiated, and part of chemical energy of the fuel is converted to electric energy and extracted.

Various types of fuel cells have been already proposed and experimentally produced, and part thereof is practically used. These fuel cells are categorized into an Alkaline Fuel Cell (AFC), a Phosphoric Acid Fuel Cell (PAFC), a Molten Carbonate Fuel Cell (MCFC), a Solid Electrolyte Fuel Cell (SOFC), a Polymer Electrolyte Fuel Cell (PEFC) and the like depending on the electrolyte used. Of the foregoing fuel cells, the PEFC is operatable at lower temperature such as about from 30 deg C. to 130 deg C., compared to the other types of fuel cells.

As a fuel of the fuel cell, various flammable substances such as hydrogen and methanol is usable. However, a gas fuel such as hydrogen needs a storage cylinder or the like, and thus the gas fuel is not suitable for realizing a small-sized fuel cell. Meanwhile, a liquid fuel such as methanol is advantageous with regard to the characteristics that the liquid fuel can be easily stored. Specially, the DMFC has an advantage that the DMFC does not need a reformer to extract hydrogen from the fuel, and accordingly the structure is simplified and a small-sized fuel cell can be thereby easily realized.

In the DMFC, in general, fuel methanol is supplied as a low-concentrated or a high-concentrated aqueous solution, or as pure methanol gas state to a fuel electrode. The supplied methanol is oxidized into carbon dioxide in a catalyst layer of the fuel electrode. Protons (H⁺) generated then are moved to an oxygen electrode through an electrolyte membrane that separates the fuel electrode from the oxygen electrode, are reacted with oxygen in the oxygen electrode to generate water. The reactions initiated in the fuel electrode, the oxygen electrode, and the entire DMFC are expressed as Chemical formula 1.

(Chemical formula 1)

Fuel electrode: CH₃OH+H₂O→CO₂+6e⁻+6H⁺

Oxygen electrode: (3/2)O₂+6e⁻+6H⁺→3H₂O

Entire DMFC: CH₃OH+(3/2)O₂→CO₂+2H₂O

The energy density of methanol as the fuel of the DMFC is theoretically 4.8 kW/L, which is 10 times or more the energy density of a general lithium ion secondary battery. That is, the fuel cell using methanol as the fuel has a high possibility to obtain a higher energy density than that of the lithium ion secondary battery. Accordingly, among the various fuel cells, the DMFC is most likely to be used as an energy source for mobile devices and electric automobiles.

However, in the DMFC, there is a problem that the output voltage in the actual power generation is lowered to about 0.6 V or less, despite its theoretical voltage of 1.23 V. Such lowering of the output voltage is caused by voltage drop due to internal resistance of the DMFC. In the DMFC, internal resistance such as resistance associated with reaction initiated in the both electrodes, resistance associated with moving of substances, resistance generated when protons are moved through the electrolyte membrane, and contact resistance exists. The energy that can be actually extracted as electric energy due to oxidation of methanol is expressed as a product of an output voltage in power generation and an electric charge flowing the circuit. Thus, when the output voltage in power generation is lowered, the energy that can be actually extracted is decreased by just that much. The electric charge that can be extracted to the circuit due to oxidation of methanol is proportional to the methanol amount in the DMFC, where the entire amount of methanol is oxidized in the fuel cell according to Chemical formula 1.

Further, the DMFC has a problem of methanol crossover. The methanol crossover is a phenomenon that methanol is transported from the fuel electrode side to the oxygen electrode side through the electrolyte membrane by two mechanisms: a phenomenon that methanol is diffused and moved due to a methanol concentration difference between the fuel electrode side and the oxygen electrode side; and an electroosmotic phenomenon in which water is moved associated with proton movement and thus hydrated methanol is conveyed.

When the methanol crossover is generated, the transported methanol is oxidized in the catalyst layer of the oxide electrode. The methanol oxidation reaction on the oxidation electrode side is the same as the foregoing oxidation reaction on the fuel electrode side, but may cause lowering of the output voltage of the DMFC (for example, refer to Non Patent Document 1). Further, methanol is not used for power generation on the fuel electrode side and consumed on the oxygen electrode side, and therefore the electric quantity that can be extracted to the circuit is decreased by just that much. Further, since the catalyst layer of the oxygen electrode is not a platinum (Pt)-ruthenium (Ru) alloy catalyst but a platinum (Pt) catalyst, carbon monoxide (CO) is easily absorbed to the catalyst surface, and thus poisoning of the catalyst may be caused.

As described above, the DMFC has the two problems that are the voltage lowering caused by the internal resistance and the methanol crossover, and the fuel consumption due to the methanol crossover. These problems cause lowering of power generation efficiency of the DMFC. Therefore, to improve the power generation efficiency of the DMFC, research and development to improve the characteristics of the material composing the DMFC and research and development to optimize the operation conditions of the DMFC have been actively made.

The researches to improve the characteristics of the material composing the DMFC include researches on the electrolyte membrane and researches on the catalyst on the fuel electrode side. For the electrolyte membrane, currently, a polyperfluoroalkyl sulfonic acid-based resin membrane (“Nafion (registered trademark),” manufactured by Du Pont) is generally used. As an electrolyte membrane having higher proton conductivity and higher methanol transportation block performance than those of the polyperfluoroalkyl sulfonic acid-based resin membrane, a fluorine-based polymer membrane, a carbon hydride-based polymer electrolyte membrane, a hydro gel-based electrolyte membrane and the like have been considered. For the catalyst on the fuel electrode side, research and development have been made on a catalyst having higher activity than that of the platinum (Pt)-ruthenium (Ru) alloy catalyst that is currently and generally used.

Improving the characteristics of the component material of the fuel cell as above is appropriate as a means to improve the power generation efficiency of the fuel cell. However, as the actual state that the best suited catalyst to solve the foregoing two problems has not been found, under the present situation, no best suited electrolyte membrane has been found.

Non Patent Document 1: “Description of Fuel Cell System,” Ohmsha, Ltd., p. 66

Patent Document 1: Japanese Unexamined Patent Application Publication No. 59-90336

In Patent Document 1, a sulfuric acid electrolytic solution type fuel cell in which sulfuric acid is used as the electrolyte and a mixed liquid of methanol and sulfuric acid is supplied as a fuel is disclosed.

In the foregoing structure, however, sulfuric acid is used as the electrolyte. The sulfuric acid is diluted sulfuric acid having a concentration of about from 0.5 M to 1 M. However, sulfuric acid is nonvolatile differently from hydrochloric acid or the like, and thus there is a possibility to cause a safety problem even if sulfuric acid having a low concentration is used. For example, there is a possibility that water is evaporated depending on the power generation environment. In this case, the diluted sulfuric acid is changed to concentrated sulfuric acid. Then, if a portion contacting with a battery package or a fluid is made of a metal, it may result in corrosion. Further, even if a member is made of a resin, there are a few materials that resist the concentrated sulfuric acid. Therefore, practical use of the sulfuric acid electrolytic solution type fuel cell in which sulfuric acid is used as the electrolyte has a slim chance.

### SUMMARY

In view of the foregoing problems, it is an object of the present disclosure to provide an ion conductor that has high ion conductivity, is hardly affected by environmental change and thus can improve the safety and a fuel cell using it.

An ion conductor according to an embodiment contains an ionic solid having ion conductivity and a dispersion medium for dispersing the ionic solid. “Ionic solid” herein means an ion-exchangeable solid. Examples thereof include an ion-exchange resin.

A fuel cell according to an embodiment includes a fuel electrode, an oxygen electrode, and an ion conductor between the fuel electrode and the oxygen electrode. The ion conductor is composed of the ion conductor according to the present invention.

According to the ion conductor of an embodiment, the ionic solid having ion conductivity is dispersed in the dispersion medium. Therefore, despite the solid dispersion solution, extremely high ion conductivity is obtainable. In addition, differently from sulfuric acid used as the conventional electrolyte fluid, when the dispersion medium is evaporated due to the environmental change, only the ionic solid remains, and thus there is no possibility to corrode the surrounding members to improve the safety. Consequently, the ion conductor is suitable as an electrolyte of an electrochemical device such as a fuel cell.

Additional features and advantages are described herein, and will be apparent from, the following Detailed Description and the figures.

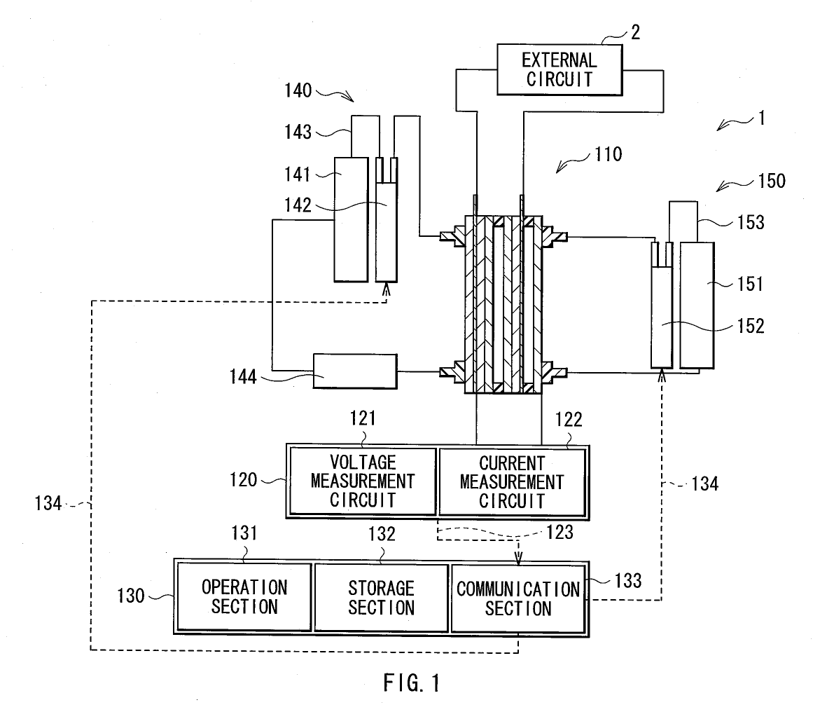

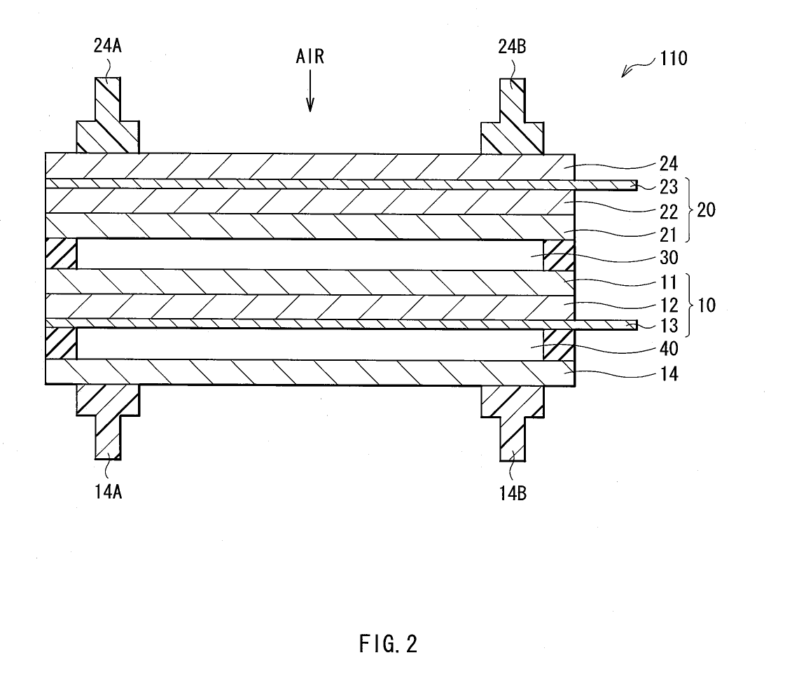

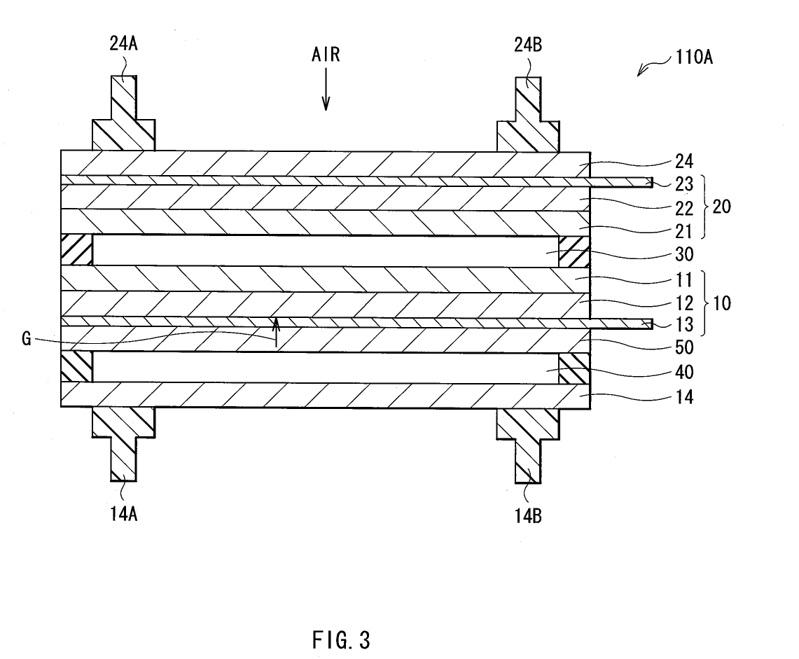

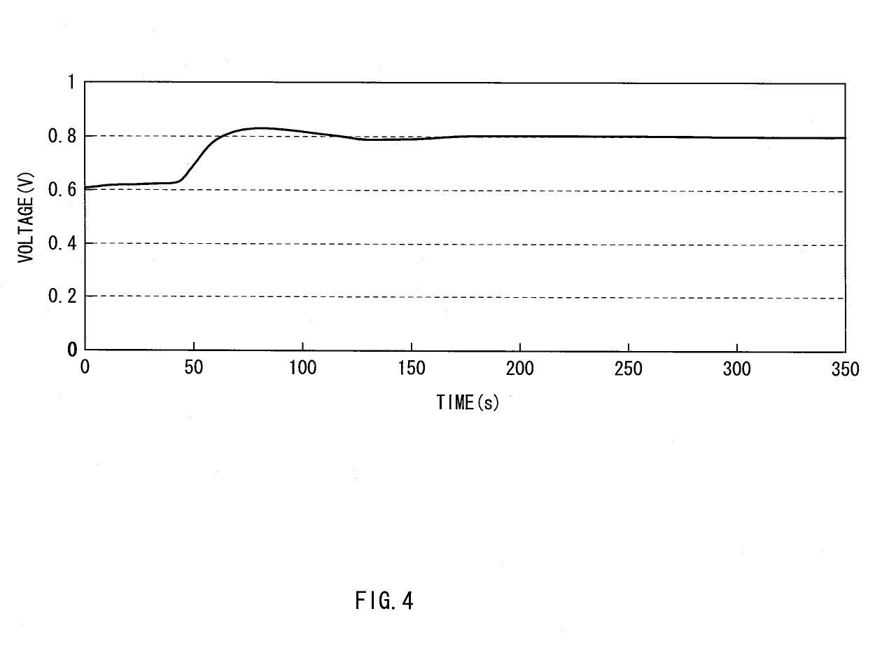

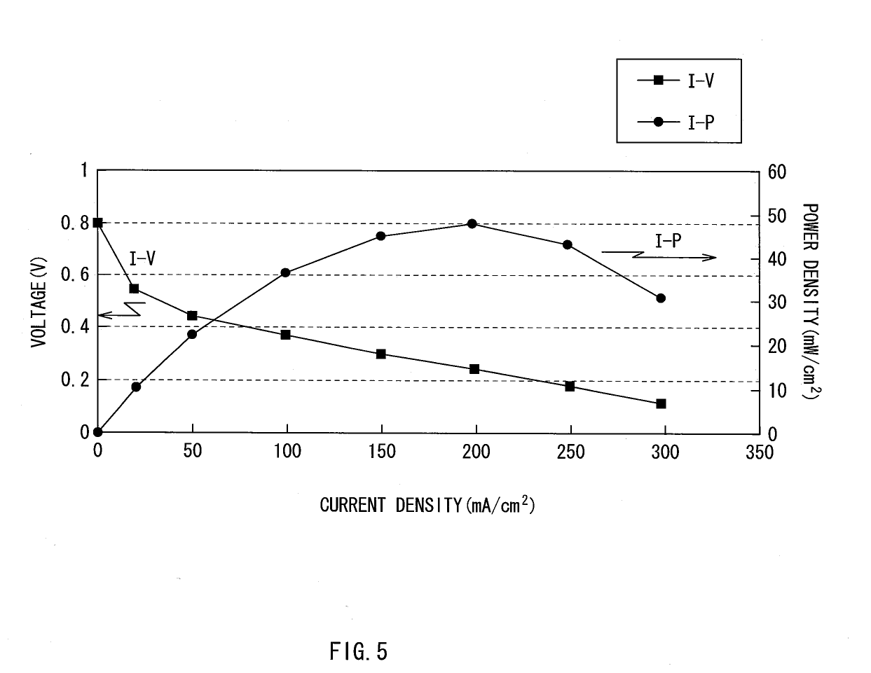

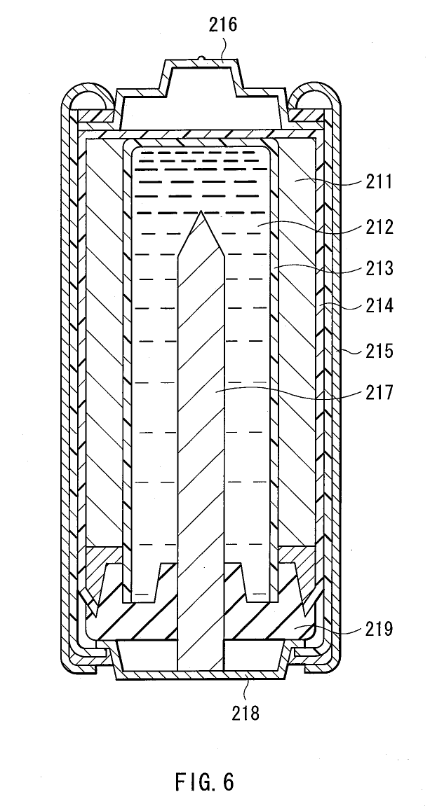

### BRIEF DESCRIPTION OF THE FIGURES

[FIG. 1] A diagram showing a schematic configuration of an electronic device comprising a fuel cell system according to a first embodiment.

[FIG. 2] A view showing a structure of a fuel cell shown in FIG. 1.

[FIG. 3] A view showing a structure of a fuel cell according to a second embodiment.

[FIG. 4] A diagram showing a result of an example in an embodiment.

[FIG. 5] A diagram showing a result of the example in an embodiment.

[FIG. 6] A view showing a structure of an alkali manganese battery using an ion conductor in an embodiment.

### DETAILED DESCRIPTION

Embodiments will be hereinafter described in detail.

### First Embodiment

FIG. 1 shows a schematic configuration of an electronic device having a fuel cell system according to a first embodiment. The electronic device is, for example, a mobile device such as a mobile phone and a PDA (Personal Digital Assistant) or a notebook PC (Personal Computer). The electronic device includes a fuel cell system 1 and an external circuit (load) 2 driven by electric energy generated in the fuel cell system 1.

The fuel cell system 1 includes, for example, a fuel cell 110, a measurement section 120 for measuring an operation state of the fuel cell 110, and a control section 130 for determining the operation condition of the fuel cell 110 based on the measurement result by the measurement section 120. The fuel cell system 1 further includes an electrolyte supply section 140 for supplying a first fluid F1 containing an electrolyte and a fuel supply section 150 for supplying a second fluid F2 containing a fuel to the fuel cell 110. It is because in an electrolyte membrane, a binder for the purpose of fixation needs to be added to a resin having ion conductivity (proton conductivity), and thus, the ion conductivity (proton conductivity) is largely decreased than that in the bulk state. Further, there becomes no possibility that the proton conductivity is lowered due to deterioration of the electrolyte membrane and drying of the electrolyte membrane. Problems such as flooding and moisture control in the oxygen electrode can be also thereby solved.

The first fluid F1 containing an electrolyte contains an ionic solid having ion conductivity (proton (H⁺) conductivity) and a dispersion medium for dispersing the ionic solid. Thereby, in the fuel cell 110, the ion conductivity of the first fluid F1 containing an electrolyte is improved, and the safety is able to be improved by hardly being affected by environmental change.

As the ionic solid, for example, an ion-exchange resin is preferable. The ion-exchange resin is a solid granular polymer having the property of insolubility in water. When the ion-exchange resin is ionized in water, the ion-exchange resin shows the property as an acid, an alkali, or a salt. Specifically, an acid type (type H) of a styrene-based cation-exchange resin (“Amberlyst (registered trademark)” or “Amberlite (registered trademark),” manufactured by Rohm and Haas Company), or a polyperfluoroalkyl sulfonic acid-based resin (“Nafion (registered trademark),” manufactured by Du Pont) is cited. Such an ion-exchange resin enables to be easily dispersed in a dispersion medium by being pulverized into fine particles as will be described later, for example, and accordingly enables to be utilized as a fluid electrolyte.

As the dispersion medium, for example, water is cited. However, the dispersion medium is not limited to water, and other dispersion medium may be used.

As the second fluid F2 containing a fuel, for example, methanol is cited. In addition to methanol, the second fluid F2 containing a fuel may be other alcohol such as ethanol and dimethyl ether.

FIG. 2 shows a structure of the fuel cell 110 shown in FIG. 1. The fuel cell 110 is a so-called Direct Methanol Flow Based Fuel Cell (DMFFC). The fuel cell 110 has a structure in which a fuel electrode (anode) 10 and an oxygen electrode (cathode) 20 are oppositely arranged. Between the fuel electrode 10 and the oxygen electrode 20, an electrolyte flow path 30 for flowing the first fluid F1 containing an electrolyte is provided. Outside of the fuel electrode 10, that is, on the other side of the oxygen electrode 20, a fuel flow path 40 for flowing the second fluid F2 containing a fuel is provided. That is, the fuel electrode 10 has a function as a separation membrane that separates the first fluid F1 containing an electrolyte from the second fluid F2 containing a fuel.

The fuel electrode 10 has a laminated structure in which a catalyst layer 11, a diffusion layer 12, and a current collector 13 are sequentially layered from the oxygen electrode 20 side. The laminated structure is contained in a package member 14. The oxygen electrode 20 has a laminated structure in which a catalyst layer 21, a diffusion layer 22, and a current collector 23 are sequentially layered from the fuel electrode side. The laminated structure is contained in a package member 24. Air or oxygen is supplied to the oxygen electrode 20 through the package member 24.

The catalyst layers 11, 21 are made of a simple substance or an alloy of a metal such as palladium (Pd), platinum (Pt), iridium (Ir), rhodium (Rh), and ruthenium (Ru) as a catalyst. In addition to the catalyst, a proton conductor and a binder may be contained in the catalyst layers 11, 21. As the proton conductor, the foregoing polyperfluoroalkyl sulfonic acid-based resin (“Nafion (registered trademark),” manufactured by Du Pont) or other resin having proton conductivity is cited. The binder is added in order to maintain the strength and the flexibility of the catalyst layers 11, 21. As the binder, for example, a resin such as polytetrafluoroethylene (PTFE) and polyvinylidene fluoride (PVDF) is cited.

The diffusion layers 12, 22 are made of, for example, a carbon cloth, a carbon paper, or a carbon sheet. The diffusion layers 12, 22 are desirably water-repellent with the use of polytetrafluoroethylene (PTFE) or the like.

The current collectors 13, 23 are made of, for example, a titanium (Ti) mesh.

The package members 14, 24 are, for example, 2.0 mm thick, and are made of a material such as a titanium (Ti) plate that can be generally purchased. The material thereof is not particularly limited. The thickness of the package members 14, 24 is desirably thin as much as possible.

In the electrolyte flow path 30 and the fuel flow path 40, for example, a fine flow path is formed by processing a resin sheet. The electrolyte flow path 30 and the fuel flow path 40 are adhered to the fuel electrode 10. The number of the flow path is not limited. The width, the height, and the length of the flow path are not particularly limited, but are desirably small.

The electrolyte flow path 30 is connected to the electrolyte supply section 140 (not shown in FIG. 2, and refer to FIG. 1) through an electrolyte inlet 24A and an electrolyte outlet 24B provided in the package member 24. The first fluid F1 containing an electrolyte is supplied from the electrolyte supply section 140. The fuel flow path 40 is connected to the fuel supply section 150 (not shown in FIG. 2, and refer to FIG. 1) through a fuel inlet 14A and a fuel outlet 14B provided in the package member 14. The second fluid F2 containing a fuel is supplied from the fuel supply section 150.

The measurement section 120 shown in FIG. 1 is intended to measure the operating voltage and the operating current of the fuel cell 110. For example, the measurement section 120 has a voltage measurement circuit 121 for measuring the operating voltage of the fuel cell 110, a current measurement circuit 122 for measuring the operating current, and a communication line 123 for sending the obtained measurement result to the control section 130.

The control section 130 shown in FIG. 1 controls the electrolyte supply parameter and the fuel supply parameter as operation conditions of the fuel cell 110 based on the measurement result of the measurement section 120. For example, the control section 130 has an operation section 131, a storage (memory) section 132, a communication section 133, and a communication line 134. Here, the electrolyte supply parameter includes, for example, the supply flow rate of the first fluid F1 containing an electrolyte. The fuel supply parameter includes, for example, the supply flow rate and the supply amount of the second fluid F2 containing a fuel, and may include the supply concentration according to needs. The control section 130 can be composed of a microcomputer, for example.

The operation section 131 calculates the output of the fuel cell 110 based on the measurement result obtained by the measurement section 120, and sets the electrolyte supply parameter and the fuel supply parameter. Specifically, the operation section 131 calculates the average anode potential, the average cathode potential, the average output voltage, and the average output current by averaging the anode potentials, the cathode potentials, the output voltages, and the output currents that are sampled at a regular interval from the various measurement results inputted to the storage section 132, inputs the calculated results to the storage section 132, compares the various average values stored in the storage section 132 to each other, and thereby determines the electrolyte supply parameter and the fuel supply parameter.

The storage section 132 stores the various measurement values sent from the measurement section 120, the various average values calculated by the operation section 131 and the like.

The communication section 133 has a function to receive the measurement result from the measurement section 120 through the communication line 123 and input the received measurement result to the storage section 132, and a function to output respective signals for setting the electrolyte supply parameter and the fuel supply parameter to the electrolyte supply section 140 and the fuel supply section 150 through the communication line 134.

The electrolyte supply section 140 shown in FIG. 1 includes an electrolyte storage section 141, an electrolyte supply adjustment section 142, an electrolyte supply line 143, and a separation chamber 144. The electrolyte storage section 141 stores the first fluid F1 containing an electrolyte, and is composed of, for example, a tank or a cartridge. The electrolyte supply adjustment section 142 adjusts the supply flow rate of the first fluid F1 containing an electrolyte. The electrolyte supply adjustment section 142 is not particularly limited as long as the electrolyte supply adjustment section 142 can be driven by a signal from the control section 130. The electrolyte supply adjustment section 142 is preferably composed of, for example, a valve driven by a motor or a piezoelectric device or an electromagnetic pump. The separation chamber 144 is intended to separate methanol, since a small amount of methanol may be mixed in the first fluid F1 containing an electrolyte discharged from the electrolyte outlet 24B. The separation chamber 144 is provided in the vicinity of the electrolyte outlet 24B. As a methanol separation mechanism, the separation chamber 144 includes a filter or a mechanism to remove methanol by combustion, reaction, or evaporation.

The fuel supply section 150 shown in FIG. 1 has a fuel storage section 151, a fuel supply adjustment section 152, and a fuel supply line 153. The fuel storage section 151 stores the second fluid F2 containing a fuel, and is composed of, for example, a tank or a cartridge. The fuel supply adjustment section 152 adjusts the supply flow rate and the supply amount of the second fluid F2 containing a fuel. The fuel supply adjustment section 152 is not particularly limited as long as the fuel supply adjustment section 152 can be driven by a signal from the control section 130. The fuel supply adjustment section 152 is preferably composed of, for example, a valve driven by a motor or a piezoelectric device or an electromagnetic pump. The fuel supply section 150 may include a concentration adjustment section (not shown) for adjusting the supply concentration of the second fluid F2 containing a fuel. The concentration adjustment section can be omitted in the case of using pure (99.9%) methanol as the second fluid F2 containing a fuel, and the size of the system can be thereby more reduced.

The fuel cell system 1 is manufacturable, for example, as follows.

First, for example, an alloy containing platinum (Pt) and ruthenium (Ru) at a given ratio as a catalyst and a dispersion solution of a polyperfluoroalkyl sulfonic acid resin (“Nafion (registered trademark),” manufactured by Du Pont) are mixed at a given ratio. Thereby, the catalyst layer 11 of the fuel electrode 10 is formed. The catalyst layer 11 is thermal compression-bonded to the diffusion layer 12 made of the foregoing material. Further, the current collector 13 made of the foregoing material is thermal compression-bonded by using a hot-melt adhesive or an adhesive resin sheet. The fuel electrode 10 is thereby formed.

Further, a catalyst in which platinum (Pt) is supported by carbon and a dispersion solution of polyperfluoroalkyl sulfonic acid resin (“Nafion (registered trademark),” manufactured by Du Pont) are mixed at a given ratio. Thereby, the catalyst layer 21 of the oxygen electrode 20 is formed. The catalyst layer 21 is thermal compression-bonded to the diffusion layer 22 made of the foregoing material. Further, the current collector 23 made of the foregoing material is thermal compression-bonded by using a hot-melt adhesive or an adhesive resin sheet. The oxygen electrode 20 is thereby formed.

Next, an adhesive resin sheet is prepared. A flow path is formed in the resin sheet, and thereby the electrolyte flow path 30 and the fuel flow path 40 are fabricated, which are thermal compression-bonded to the both sides of the fuel electrode 10.

Subsequently, the package members 14, 24 made of the foregoing material are fabricated. In the package member 14, the fuel inlet 14A and the fuel outlet 14B that are made of, for example, a resin joint are provided. In the package member 24, the electrolyte inlet 24A and the electrolyte outlet 24B that are made of, for example, a resin joint are provided.

After that, the fuel electrode 10 and the oxygen electrode 20 are oppositely arranged with the electrolyte flow path 30 in between so that the fuel flow path 30 is located outside, and the resultant lamination is contained in the package members 14, 24. Thereby, the fuel cell 110 shown in FIG. 2 is fabricated.

The fuel cell 110 is incorporated in the system having the measurement section 120, the control section 130, the electrolyte supply section 140, and the fuel supply section 150 having the foregoing structure. The fuel inlet 14A and the fuel outlet 14B are connected to the fuel supply section 150 through the fuel supply line 153 made of, for example, a silicon tube. The electrolyte inlet 24A and the electrolyte outlet 24B are connected to the electrolyte supply section 140 through the electrolyte supply line 143 made of, for example, a silicon tube. As the first fluid F1 containing an electrolyte, an ion conductor is prepared by mixing the foregoing ion-exchange resin (for example, 15 wt %) with water as a dispersion medium, and pulverizing the mixture by a ball mill. As the second fluid F2 containing a fuel, methanol is used. Consequently, the fuel cell system 1 shown in FIG. 1 is fabricated.

In the fuel cell system 1, the second fluid F2 containing a fuel is supplied to the fuel electrode 10, and reaction is initiated to generate a proton and an electron. The proton is moved to the oxygen electrode 20 through the first fluid F1 containing an electrolyte, and then is reacted with an electron and oxygen to generate water. The reactions initiated in the fuel electrode 10, the oxygen electrode 20, and the entire fuel cell 110 are expressed as Chemical formula 2. Thereby, part of the chemical energy of methanol, which is fuel, is converted to electric energy, a current is extracted from the fuel cell 110, and the external circuit 2 is driven. Carbon dioxide generated in the fuel electrode 10 and water generated in the oxygen electrode 20 are flown together with the first fluid F1 containing an electrolyte, and removed.

(Chemical formula 2)

Fuel electrode 10: CH₃OH+H₂O→CO₂+6e⁻+6H⁺

Oxygen electrode 20: (3/2)O₂+6e⁻+6H⁺→3H₂O

Entire fuel cell 110: CH₃OH+(3/2)O₂→CO₂+2H₂O

Further, since the fuel electrode 10 is provided between the electrolyte flow path 40 and the fuel flow path 30, almost all fuel is reacted when passing through the fuel electrode 10. If unreacted fuel passes through the fuel electrode 10, the unreacted fuel is carried out from the fuel cell 110 by the first fluid F1 containing an electrolyte before the unreacted fuel is infiltrated into the oxygen electrode 20. Thereby, crossover of the fuel is significantly suppressed. Therefore, the high-concentrated fuel is utilizable, and the high energy density characteristics as an inherent advantage of the fuel cell are appropriately utilized.

While the fuel cell 110 is operated, the operating voltage and the operating current of the fuel cell 110 are measured by the measurement section 120. Based on the measurement results, the control section 130 controls the electrolyte supply parameter and the fuel supply parameter described above as operation conditions of the fuel cell 110. The measurement by the measurement section 120 and the parameter control by the control section 130 are frequently repeated. According to the characteristics change of the fuel cell 110, the supply states of the first fluid F1 containing an electrolyte and the second fluid F2 containing a fuel are optimized.

Here, as the first fluid F1 containing an electrolyte, the ion conductor in which the ionic solid having ion conductivity is dispersed in the dispersion medium is used. Thus, despite the solid dispersion solution, significantly high ion conductivity is obtainable. Further, differently from sulfuric acid used as the conventional electrolyte fluid, if the dispersion medium is evaporated according to the environmental change, only the ionic solid remains and thus there is no possibility to corrode the surrounding members, and the safety is improved.

As described above, according to this embodiment, the ion conductor in which the ionic solid having ion conductivity is dispersed in the dispersion medium is used as the first fluid F1 containing an electrolyte. Thus, despite the solid dispersion solution, significantly high ion conductivity is obtainable. Further, differently from sulfuric acid used as the conventional electrolyte fluid, if the dispersion medium is evaporated according to the environmental change, only the ionic solid remains and thus there is no possibility to corrode the surrounding members, the safety can be improved, and the ionic solid can be easily collected and recycled. Thus, the ion conductor according to this embodiment is suitable as an electrolyte of an electrochemical device such as a fuel cell.

### Second Embodiment

FIG. 3 shows a structure of a fuel cell 110A according to a second embodiment. The fuel cell 110A has the same structure as that of the fuel cell 110 described in the first embodiment, except that a gas-liquid separation membrane 50 is provided between the fuel flow path 40 and the fuel electrode 10. Therefore, a description will be given by using the same referential symbols for the corresponding elements.

The gas-liquid separation membrane 50 may be made of a membrane in which liquid alcohol such as polytetrafluoroethylene (PTFE), polyvinylidene fluoride (PVDF), and polypropylene (PP) is not able to be permeated.

The fuel cell 110A and the fuel cell system 1 using it is manufacturable in the same way as that of the first embodiment, except that the gas-liquid separation membrane 50 is provided between the fuel flow path 40 and the fuel electrode 10.

In the fuel cell system 1, a current is extracted from the fuel cell 110A, and the external circuit 2 is driven, as in the first embodiment. Here, the gas-liquid separation membrane 50 is provided between the fuel flow path 40 and the fuel electrode 10. Therefore, when pure methanol, which is fuel, in a state of liquid is flown in the fuel flow path 40, pure methanol is naturally volatilized, passes through the gas-liquid separation membrane 50 in a state of gas G through the face where the fuel flow path 40 is contacted with the gas-liquid separation membrane 50, and is supplied to the fuel electrode 10. Thus, the fuel is efficiently supplied to the fuel electrode 10, and reaction is made stably. Further, since the fuel in a state of gas is supplied to the fuel electrode 10, the electrode reactivity becomes high, crossover is hardly generated, and high performance is obtained in the electronic device having the external circuit 2 with a high load.

If gas methanol passing through the fuel electrode 10 exists, such methanol is removed by the first fluid F1 containing an electrolyte before reaching the oxygen electrode 20, as in the first embodiment.

As above, in this embodiment, the gas-liquid separation membrane 50 is provided between the fuel flow path 40 and the fuel electrode 10. Thus, pure (99.9%) methanol can be used as the second fluid F2 containing a fuel, and the high energy density characteristics as the characteristics of the fuel cell are further appropriately utilized. Further, the reaction stability and the electrode reactivity are improved, and crossover is suppressed as well. Thus, high performance is obtainable in the electronic device having the external circuit 2 with a high load. Further, the concentration adjustment section for adjusting the supply concentration of the second fluid F2 containing a fuel can be omitted in the fuel supply section 150, and the size of the system can be thereby more reduced.

### EXAMPLE

Further, a description will be given of a specific example of the present invention. In the following example, the fuel cell 110A having a structure similar to that of FIG. 3 was fabricated, and the characteristics were evaluated. Thus, in the following example, a description will be given with reference to FIG. 1 and FIG. 3, and by using the same referential symbols.

The fuel cell 110A having a structure similar to that of FIG. 3 was fabricated. First, an alloy containing platinum (Pt) and ruthenium (Ru) at a given ratio as a catalyst and a dispersion solution of a polyperfluoroalkyl sulfonic acid resin (“Nafion (registered trademark),” manufactured by Du Pont) were mixed at a given ratio. Thereby, the catalyst layer 11 of the fuel electrode 10 was formed. The catalyst layer 11 was thermal compression-bonded to the diffusion layer 12 made of the foregoing material (HT-2500, manufactured by E-TEK Co.) for 10 minutes under the conditions of 150 deg C. and 249 kPa. Further, the current collector 13 made of the foregoing material was thermal compression-bonded by using a hot-melt-based adhesive or an adhesive resin sheet. The fuel electrode 10 was thereby formed.

Further, a catalyst in which platinum (Pt) was supported by carbon and a dispersion solution of polyperfluoroalkyl sulfonic acid resin (“Nafion (registered trademark),”manufactured by Du Pont) were mixed at a given ratio. Thereby, the catalyst layer 21 of the oxygen electrode 20 was formed. The catalyst layer 21 was thermal compression-bonded to the diffusion layer 22 made of the foregoing material (HT-2500, manufactured by E-TEK Co.) in the same manner as that of the catalyst layer 11 of the fuel electrode 10. Further, the current collector 23 made of the foregoing material was thermal compression-bonded in the same manner as that of the current collector 13 of the fuel electrode 10. The oxygen electrode 20 was thereby formed.

Next, an adhesive resin sheet was prepared. A flow path was formed in the resin sheet, and thereby the electrolyte flow path 30 and the fuel flow path 40 were formed, which were thermal compression-bonded to the both sides of the fuel electrode 10.

Subsequently, the package members 14, 24 made of the foregoing material were fabricated. In the package member 14, the fuel inlet 14A and the fuel outlet 14B that were made of, for example, a resin joint were provided. In the package member 24, the electrolyte inlet 24A and the electrolyte outlet 24B that were made of, for example, a resin joint were provided.

After that, the fuel electrode 10 and the oxygen electrode 20 were oppositely arranged with the electrolyte flow path 30 in between so that the fuel flow path 40 was located outside, and the resultant lamination was contained in the package members 14, 24. At that time, the gas-liquid separation membrane 50 (manufactured by Millipore Co.) was provided between the fuel flow path 40 and the fuel electrode 10. Thereby, the fuel cell 110A shown in FIG. 3 was fabricated.

The fuel cell 110A was incorporated in the system having the measurement section 120, the control section 130, the electrolyte supply section 140, and the fuel supply section 150 having the foregoing structure. Thereby, the fuel cell system 1 shown in FIG. 1 was structured. At that time, the electrolyte supply adjustment section 142 and the fuel supply adjustment section 152 were composed of a diaphragm constant rate pump (manufactured by KNF Co., Ltd.). Each pump was directly connected to the fuel inlet 14A and the electrolyte inlet 24A through the electrolyte supply line 143 and the fuel supply line 153 made of a silicon tube. Thereby, the first fluid F1 containing an electrolyte and the second fluid F2 containing a fuel were respectively supplied to the electrolyte flow path 30 and the fuel flow path 40 at a given flow rate. As the first fluid F1 containing an electrolyte, an ion conductor prepared by mixing 15 wt % of a styrene cation-exchange resin (“Amberlyst (registered trademark) 15,” manufactured by Sigma-Aldrich Corporation) with water as a dispersion medium, and pulverizing the mixture by a ball mill was used. The flow rate was 1.0 ml/min. As the second fluid F2 containing a fuel, pure (99.9%) methanol was used. The flow rate was 0.080 ml/min.

### Evaluation

The obtained fuel cell system 1 was connected to an electrochemical measurement device (Multistat 1480, manufactured by Solartron Co.), and the characteristics were evaluated. At that time, operation was performed in the constant current (20 mA, 50 mA, 100 mA, 150 mA, 200 mA, or 250 mA) mode, and the Open Circuit Voltage (OCV), I-V (current-voltage) characteristics, and I-P (current-power) characteristics in the initial measurement period were examined. The results are respectively shown in FIG. 4 and FIG. 5.

FIG. 4 shows the OCV in the initial measurement period. The figure shows the state of retention for about 150 seconds, and the OCV was extremely stable. Further, the significantly hither value (0.8 V) was shown compared to the OCV of a general DMFC (about from 0.4 V to 0.5 V). Thus, it was confirmed that in the case where the foregoing ion conductor was used as the fluid F1 containing an electrolyte, normal operation could be realized as a fuel cell. Further, such an extremely high OCV possibly resulted from the fact that the fuel crossover was suppressed.

Further, as understood from FIG. 5, the characteristics of the fuel cell 110A of this example were extremely favorable, and 50 mW/cm² was obtained as the power density.

That is, it was found that in the case that the ion conductor in which the ionic solid having ion conductivity was dispersed in the dispersion medium was used as the first fluid F1 containing an electrolyte, despite the solid dispersion solution, significantly high ion conductivity was obtainable and the higher OCV than that of the conventional DMFC was obtainable.

The present invention has been described with reference to the embodiments and the example. However, the present invention is not limited to the foregoing embodiments and the foregoing example, and various modifications may be made. For example, in the foregoing embodiments and the foregoing example, the description has been given of the case that the ion conductor as the first fluid F1 containing an electrolyte is always flowing in generating electric power. However, the ion conductor of the present invention is also applicable to an electrolyte static fuel cell using a liquid as an electrolyte.

Further, for example, in the foregoing embodiments and the foregoing example, the description has been specifically given of the structures of the fuel electrode 10, the oxygen electrode 20, the fuel flow path 30, and the electrolyte flow path 40. However, the structures thereof may have other structure, or may be made of other material. For example, the fuel flow path 30 may be also composed of a porous sheet or the like, in addition to the flow path obtained by processing the resin sheet as described in the foregoing embodiments and the example.

Further, for example, the material and the thickness of each element, operation conditions of the fuel cell 110 and the like are not limited to those described in the foregoing embodiments and the example. Other material, other thickness, or other operation conditions may be adopted.

In addition, in the foregoing embodiments and the example, the fuel is supplied from the fuel supply section 150 to the fuel electrode 10. However, it is possible that the fuel electrode 10 is a sealed type electrode and a fuel is supplied according to needs.

Furthermore, in the foregoing embodiments and the example, air supply to the oxygen electrode 20 is made by natural ventilation. However, air may be forcibly supplied by utilizing a pump or the like. In this case, instead of air, oxygen or a gas containing oxygen may be supplied.

In addition, the ion conductor of the embodiments is not only applied to the DMFC, but is applicable to other type of battery such as an alkali fuel cell using hydroxide ion (OH⁻) as a charge carrier. For example, in the case of the alkali fuel cell, the ion conductor of the present invention is used as an electrolyte instead of high-concentrated potassium hydrate. In the case of the alkali fuel cell, as an ionic solid, base type (type Cl) of an anion-exchange resin is preferably used.

Furthermore, the ion conductor of the embodiments is not only applied to the fuel cell, but is applicable to other electrochemical device such as an alkali manganese battery, a nickel cadmium battery, and a nickel hydrogen battery. For example, in the alkali manganese battery, as shown in FIG. 6, a cathode 211 made of MnO₂, carbon and the like and an anode 212 are arranged with a separator 213 in between. The anode 212 is made of a mixture of an electrolytic solution and zinc powder or zinc alloy powder. A gelling agent or the like may be added according to needs. The electrolytic solution is made of the ion conductor of the present invention instead of the ordinary high-concentrated alkali electrolytic solution. The cathode 211, the anode 212, and the separator 213 are contained in a shrink tube 214 in which one end is opened and the other end is closed. A package can 215 is further provided outside of the shrink tube 214. The cathode 211 is electrically connected to a cathode terminal plate 216 provided on one end of the package can 215. The anode 212 is electrically connected to an anode terminal plate 218 provided on the other end of the package can 215 via a current collector pole 217. The open end of the shrink tube 214 is sealed by a gasket 219. The current collector pole 217 penetrates the gasket 219, and is contacted with the internal face of the anode terminal plate 218.

Furthermore, in the foregoing embodiments and the foregoing example, the description has been given of the single-cell fuel cell. However, the embodiments are is applicable to a lamination type fuel cell in which a plurality of cells are layered.

In addition, in the foregoing embodiments, the description has been given of the case that the ion conductor of the embodiments are is applied to the fuel cell. However, in addition to the fuel cell, the embodiments are applicable to other electrochemical device such as a capacitor, a fuel sensor, and a display.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-8. (canceled)

9. An ion conductor comprising:
an ionic solid having ion conductivity; and
a dispersion medium for dispersing the ionic solid.

10. The ion conductor according to claim 9, wherein the ionic solid is composed of an ion-exchange resin.

11. The ion conductor according to claim 9, wherein the ion conductor composes the electrolyte in a fuel cell in which a fuel electrode and an oxygen electrode are oppositely arranged with an electrolyte in between.

12. A fuel cell comprising:
a fuel electrode;
an oxygen electrode; and
an ion conductor between the fuel electrode and the oxygen electrode, the ion conductor including
an ionic solid having ion conductivity, and
a dispersion medium for dispersing the ionic solid.

13. The fuel cell according to claim 12, wherein the dispersion medium is an ion-exchange resin.

14. The fuel cell according to claim 13, wherein the ion-exchange resin is perfluorosulfonic acid.

15. The fuel cell according to claim 12, wherein the dispersion medium includes sulfuric acid.

16. The fuel cell according to claim 12, wherein the dispersion medium includes sulfuric acid and water.
